(19) United States
(12) Patent Application Publication
(10) Pub. No.: US 2012/0097481 A1
(43) Pub. Date: Apr. 26, 2012

(54) LADDER ATTACHMENT

(75) Inventors: Christopher J. Schienke, St. Clair Shores, MI (US); Dennis A. Asselin, Harrison Township, MI (US)

(73) Assignee: CAM-K LLC, Harrison Township, MI (US)

(21) Appl. No.: 12/908,109

(22) Filed: Oct. 20, 2010

(51) Int. Cl. E06C 7/48; E06C 7/00

(52) U.S. Cl. 182/107

(57) ABSTRACT

A ladder attachment includes an elastomeric member having a rigid body including a concave recess created between first and second end legs. First and second gripper wings are connected to the elastomeric member and extend into the concave recess. Each gripper wing has multiple teeth oriented away from the body. The first and second gripper wings are separated from the body by first and second slots. The first and second gripper wings elastically deflect into the first and second slots and toward the body by a force acting on the body. The body has first and second apertures including first and second body angled surfaces oriented at an acute angle with respect to a line extending through the body and perpendicular to a planar body surface. The first and second gripper wings have a maximum thickness at the first and second connecting ends, and thinner first and second free ends.

### FIELD

The present disclosure relates to attachment devices to stabilize rung and leaning ladders.

### BACKGROUND

This section provides background information related to the present disclosure which is not necessarily prior art.

Attachments for stabilizing ladders designed to lean against an object to prevent the ladder from tipping or sliding when propped up against a supporting structure are known. An example is the ladder attachment disclosed in U.S. Pat. No. 7,575,097 which is co-owned by the assignee of the present application. Known attachments for stabilizing lean type ladders when supported against flat surfaces or against the trunks of trees or utility poles do not provide for automatic engagement between the attachment and the tree trunk or utility pole.

### SUMMARY

This section provides a general summary of the disclosure, and is not a comprehensive disclosure of its full scope or all of its features.

According to several embodiments, a ladder attachment includes an elastomeric member having a rigid body including a concave recess created between first and second end legs. First and second gripper wings are each connected at one end to the elastomeric member and extend into the concave recess. Each gripper wing has multiple teeth oriented away from the body. The first and second gripper wings are individually separated from the body by first and second slots such that the first and second gripper wings elastically deflect into the first and second slots and toward the body by a force acting on the body. The body has first and second apertures individually including first and second body angled surfaces oriented at an acute angle measured with respect to a line extending through the body and perpendicular to a planar body surface of the body.

According to further embodiments, a ladder attachment includes an elastomeric member having a rigid body including a concave recess created between first and second end legs. First and second gripper wings are individually connected at first and second connecting ends to a body cross member of the body and extend into the concave recess, each having multiple teeth oriented away from the body. The first and second gripper wings are individually separated from the body by first and second slots such that the first and second gripper wings elastically deflect into the first and second slots and toward the body by a force acting on the body. The first and second gripper wings each have a maximum thickness at the first and second connecting ends at the body cross member, and first and second free ends which are thinner than the first and second connecting ends to provide elastic flexibility of the first and second gripper wings.

According to still other embodiments, a ladder attachment for connection to a ladder includes an elastomeric member having a rigid body including a concave recess. A first gripper wing has a first connecting end and a second gripper wing has a second connecting end. The first and second connecting ends are integrally attached to the body and extend into the concave recess. Each gripper wing has multiple teeth oriented away from the body. The first and second gripper wings are individually separated from the body by first and second slots such that the first and second gripper wings elastically deflect into one of the first and second slots and toward the body by a force acting on the body. The body has first and second apertures individually including first and second body angled surfaces each oriented at an acute angle measured with respect to a line extending through the body perpendicular to a planar body surface of the body. A locking arm is releasably connected to the body and oppositely directed with respect to the teeth. The locking arm has first and second arm angled surfaces also oriented at the acute angle. The first arm angled surface is aligned with the first aperture and the second arm angled surface is aligned with the second aperture. The first and second body angled surfaces are aligned parallel to each other and parallel to the first and second arm angled surfaces.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top plan view of a body of a ladder attachment device of the present disclosure;

FIG. 2 is a top plan view of the body of FIG. 1 further showing connection of a locking arm;

FIG. 3 is a front left perspective view of the ladder attachment device of FIG. 2 connected to an upper end of a ladder;

FIG. 4 is a top plan view of the body of FIG. 1;

FIG. 5 is a front elevational view of the body of FIG. 1; and

FIG. 6 is a front elevational view of the ladder attachment device of FIG. 2 in an installed position.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

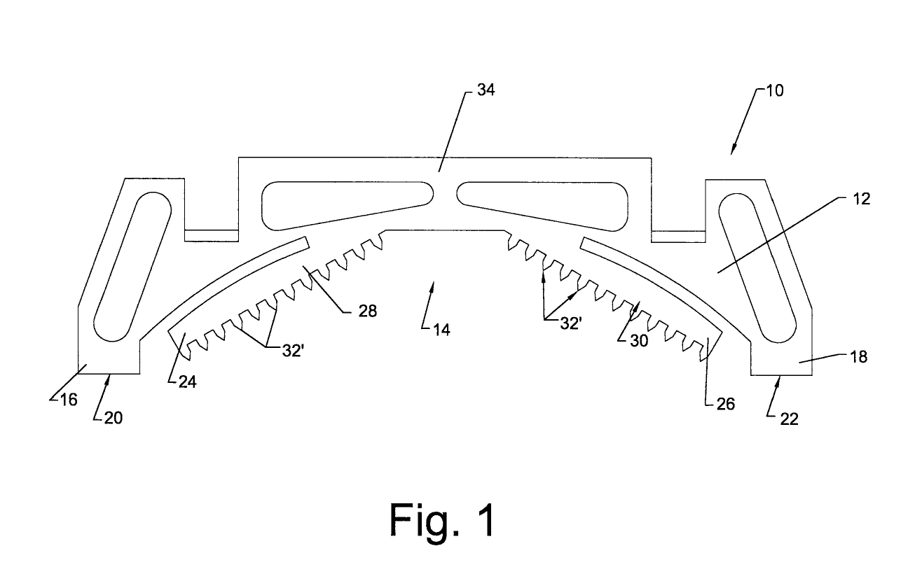

Referring to FIG. 1, a polymeric attachment device 10 includes a body 12 of a substantially rigid plastic material that can be molded for example using an injection molding process. An arcuate cavity 14 is formed on one side of body 12. First and second end legs 16, 18 having first and second end faces 20, 22 define end extents of arcuate cavity 14. First and second gripper wings 24, 26 are both positioned in and are deflectable within arcuate cavity 14. Each of the first and second gripper wings 24, 26 have a substantially straight gripper body 28, 30 with a plurality of teeth 32, 32′ directed oppositely away from a body cross member 34.

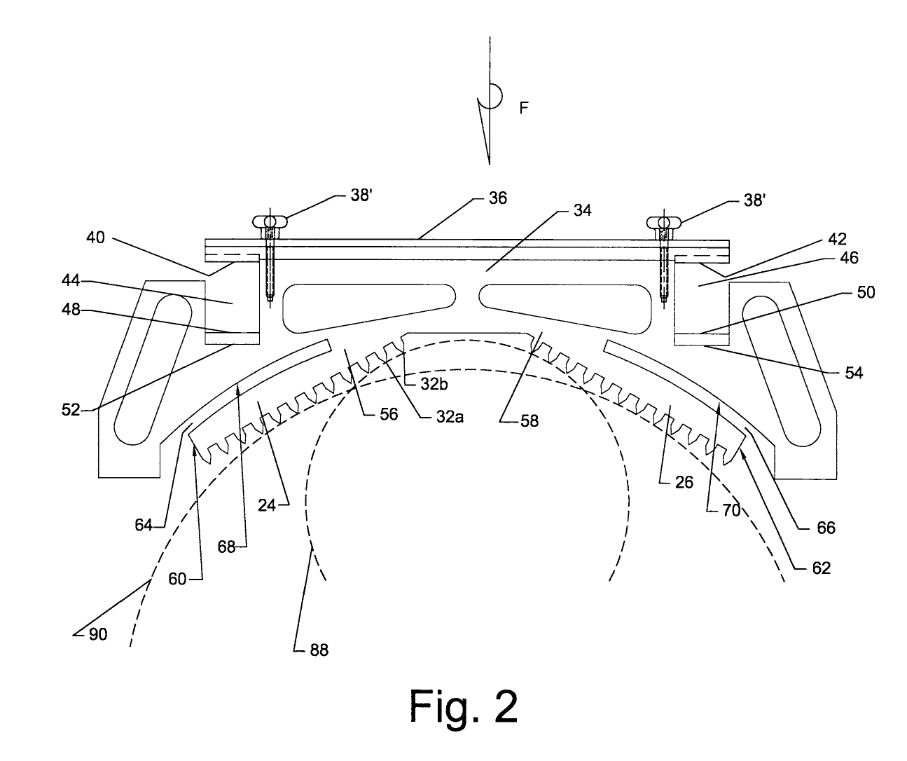

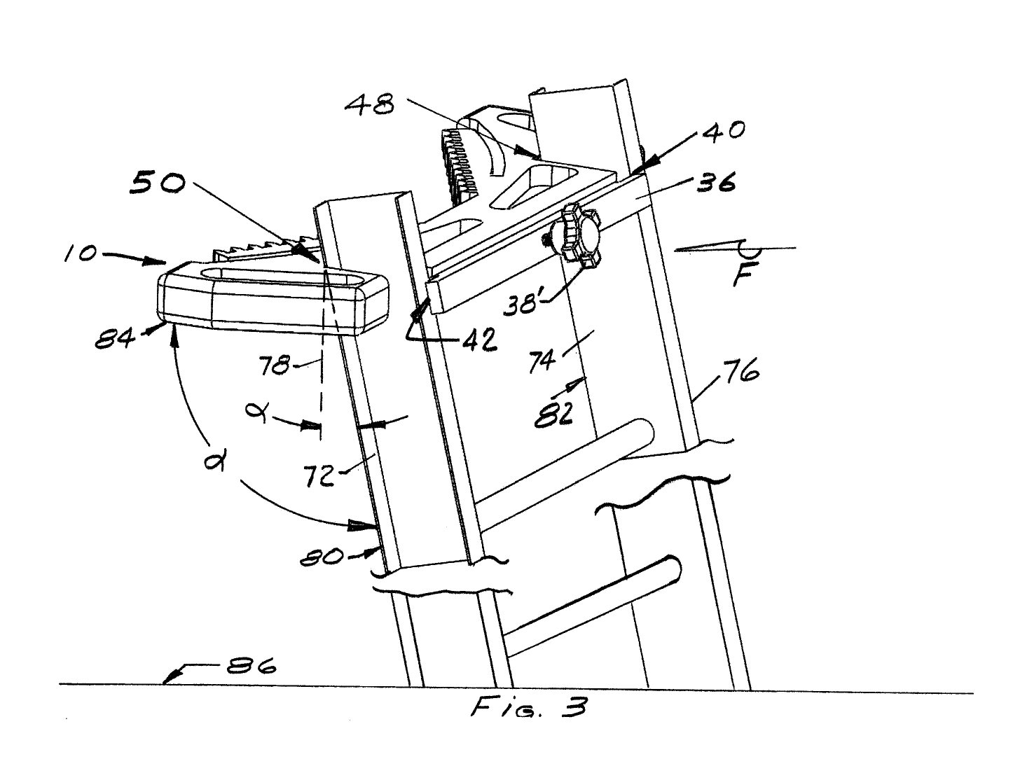

Referring to FIG. 2, attachment device 10 is completed by installation of a locking arm 36 connected such as by fastening to body cross member 34 using at least one and according to several embodiments first and second fasteners 38, 38′. The locking arm 36 has first and second arm angled surfaces 40, 42 that equal in width the first and second rectangular apertures 44, 46 of body cross member 34. Rectangular apertures 44, 46 slidably receive legs of a ladder such as an extension ladder shown and described in better detail in reference to FIG. 3. Locking arm 36 releasably connects attachment device 10 to the legs of the ladder. First and second body angled surfaces 48, 50 are created at inward end walls 52, 54 of rectangular apertures 44, 46, which will be described in reference to FIG. 3. The first and second gripper wings 24, 26 are flexibly connected by co-molding at first and second connecting ends 56, 58 to body cross member 34 such that first and second free ends 60, 62 can displace by bending occurring at connecting ends 56, 58 partially into one of first and second arcuate shaped slots 64, 66 created between first and second gripper wings 24, 26 and first and second slot walls 68, 70 of body cross member 34.

Referring to FIG. 3, attachment device 10 is shown fastened to first and second legs 72, 74 of a ladder 76 using locking arm 36 and in this embodiment one fastener 38. According to several embodiments an acute angle α is measured with respect to a line 78 extending through body 12 perpendicular to a planar body surface 84. According to several embodiments angle α is approximately 15 degrees. Angle α is repeated for each of the first and second arm angled surfaces 40, 42, and first and second body angled surfaces 48, 50. Angle α automatically orients the ladder 76 at an included angle β of approximately 105 degrees with respect to first and second planar body faces 80, 82 of the first and second legs 72, 74 of ladder 76 and planar body surface 84 of body 12. When body 12 is visually oriented approximately parallel to a ground surface 86, included angle β automatically orients ladder 76 at approximately a 4:1 pitch, based on a ladder length up to the attachment device 10 and a distance between a bottom end of ladder 76 and the tree, pole or building that attachment device 10 is resting against. This 4:1 pitch meets the Occupational Safety and Health Administration (OSHA) safety standard for leaning ladders.

With continuing reference to both FIGS. 2 and 3, because first and second gripper wings 24, 26 are straight at the junction of the teeth 32, 32′, different diameter cylindrical shaped members 88, 90 such as power poles, tree trunks or limbs, or the like can be engaged by different ones of the teeth 32, 32′ between first and second gripper wings 24, 26. When attachment device 10 is initially placed in contact with cylindrical shaped member 88 or 90 a first tooth, for example first tooth 32a of both the first and second gripper wings 24, 26 will contact the outer perimeter surface of cylindrical shaped member 88. The straight shape of first and second gripper wings 24, 26 ensures that as a horizontal component of a climber's weight is applied in a direction of force “F” against attachment device 10 at the top of the ladder 76, first and second gripper wings 24, 26 will deflect partially into the first and second arcuate shaped slots 64, 66.

This deflection into first and second arcuate shaped slots 64, 66 forces at least second ones of the teeth 32, 32′ from both first and second gripper wings 24, 26, for example both first and second teeth 32a, 32b into engagement with the cylindrical shaped member 88. This provides an “automatic gripping action” that temporarily locks the attachment device 10 into engagement with the cylindrical shaped member 88 or 90, therefore no additional strap, belt, rope, or the like is required to hold attachment device 10 in place. When force “F” is removed, for example as the climber returns to ground surface 86, the first and second gripper wings 24, 26 elastically spring back and the second ones of teeth 32, 32′ (for example second tooth 32b) from each of the first and second gripper wings 24, 26 release from cylindrical shaped member 88 or 90.

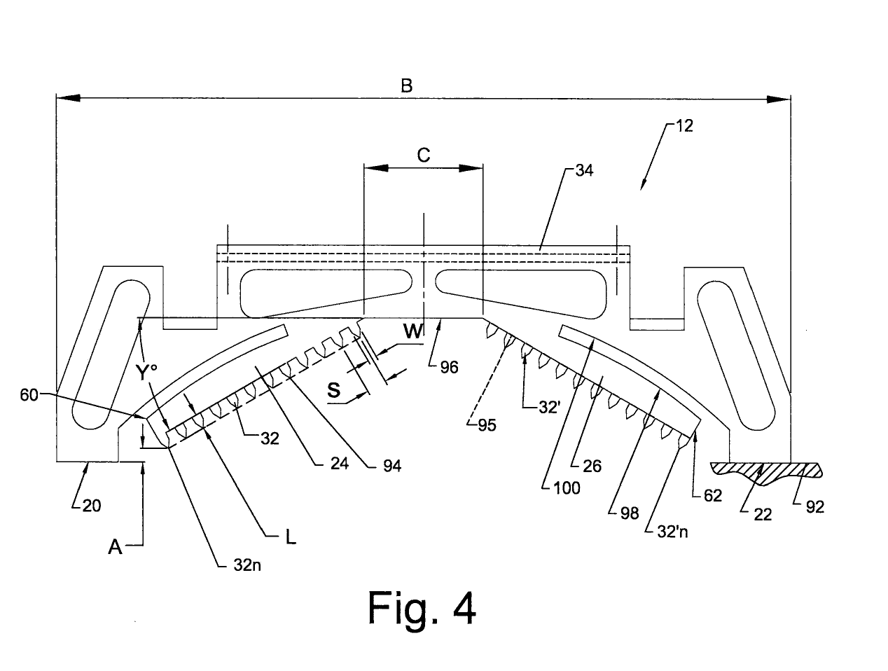

Referring to FIG. 4, the first and second end faces 20, 22 of the first and second end legs 16, 18 extend further away from body cross member 34 than end teeth 32n, 32n′ positioned proximate to the free ends 60, 62 of the first and second gripper wings 24, 26. A clearance “A” is thereby defined which permits first and second free ends 60, 62 to contact a flat surface such as an outside wall 92 of a building without the first or second free ends 60, 62 or the end teeth 32n, 32n′ also contacting outside wall 92. The gripping action provided by teeth 32, 32′ is not required for this operation. First and second end legs 16, 18 define a total width “B” of body 12 which provides maximum separation for first and second free ends 60, 62 when in contact with outside wall 92. Therefore, if attachment device 10 is in contact with outside wall 92, the first and second end faces 20, 22 of the first and second end legs 16, 18 will be the only wall contact points thereby providing a broader support base and stabilizing attachment device 10 with respect to outside wall 92. With continued reference to FIG. 3, by maintaining attachment device 10 parallel to the ground surface 86, the 4:1 pitch of ladder 76 will also be maintained during this operation.

According to several embodiments, each of the multiple teeth 32 or 32′ of each of the first and second gripper wings 24, 26 are aligned on a common straight edge 95. The first and second arcuate shaped slots 64, 66 are arcuate shaped such that an arcuate shaped rear face 98 of each of the first and second gripper wings 24, 26 defines a first radius R₁ and an arcuate shaped body face 100 positioned opposite the rear face 98 defines a second radius R₂ larger than the first radius R₁. Also, according to several embodiments each of the teeth 32, 32′ are identical in geometry, although the present disclosure is not limited to teeth having identical geometries. When identical geometry teeth are used, according to several embodiments each tooth 32, 32′ has a sharp wedge-shaped end 94, a common length “L” and a common width “W”. A tooth-to-tooth spacing “S” is repeated between any two successive ones of the teeth 32 or 32′. Both first and second gripper wings 24, 26 define an acute angle γ with respect to a surface 96 of body 12. According to several embodiments angle γ is approximately 30 degrees. Surface 96 has a surface length “C” which separates first and second the connecting ends 56, 58 of gripper wings 24, 26.

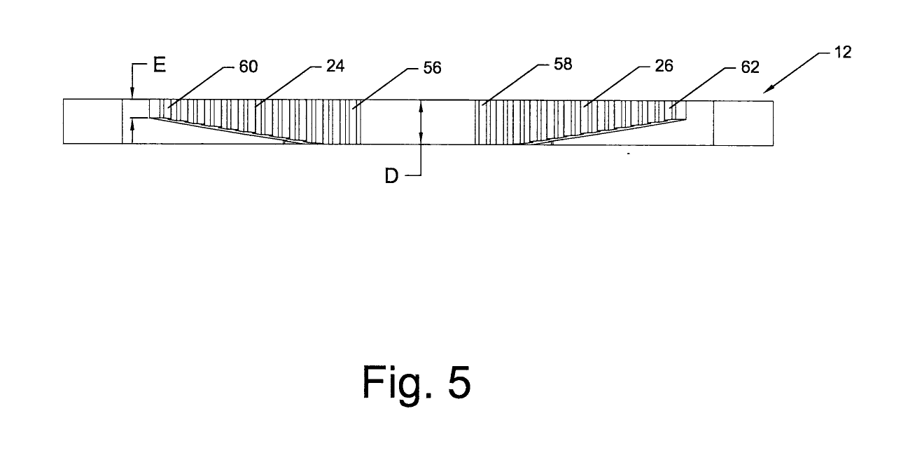

Referring to FIG. 5 and again to FIG. 2, the first and second gripper wings 24, 26 are widest or thickest at the first and second connecting ends 56, 58 at body cross member 34. First and second gripper wings 24, 26 have a maximum thickness “D” at connecting ends 56, 58 which is substantially equal to a thickness of the body cross member 34 and body 12. The first and second free ends 60, 62 are their narrowest and thinner than first and second connecting ends 56, 58 to provide limited elastic flexibility of first and second gripper wings 24, 26 where they contact the largest diameter cylindrical shaped member 90. Free ends 60, 62 have a reduced thickness “E” which is thinner than maximum thickness “D”. According to several embodiments, reduced thickness “E” is approximately half of maximum thickness “D”. The thickness of first and second gripper wings 24, 26 from connecting ends 56, 58 to free ends 60, 62 continuously decreases between maximum thickness “D” and minimum thickness “E”.

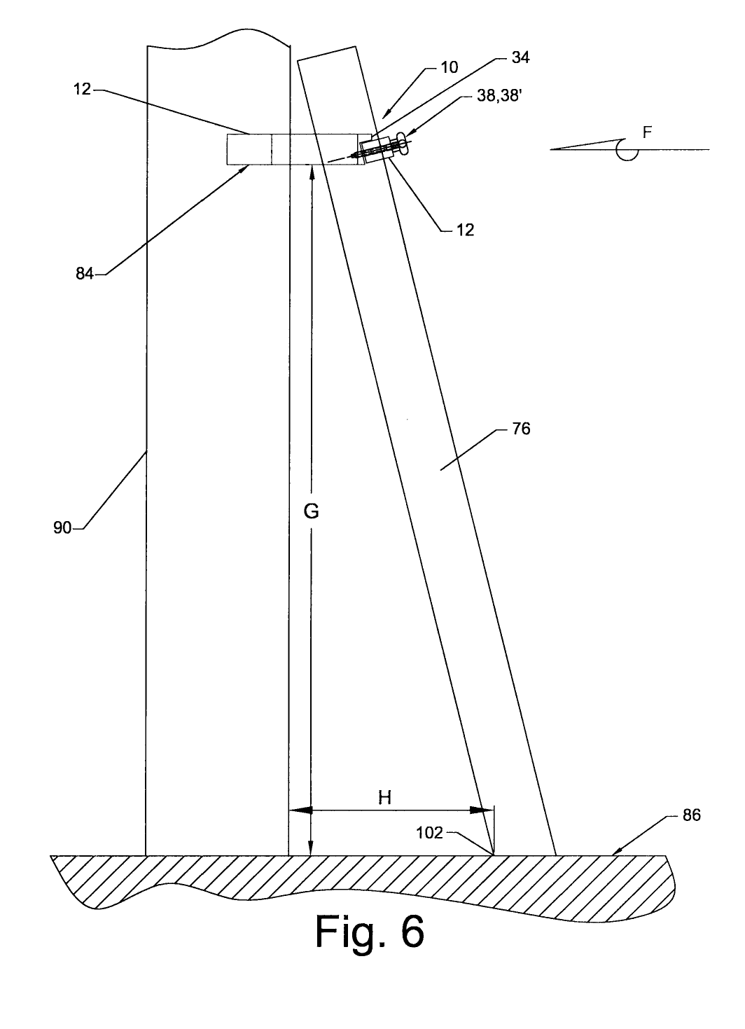

Referring to FIG. 6, ladder attachment device 10 is shown attached to ladder 76 using first and second fasteners 38, 38′ (only first fastener 38 is clearly visible in this view) to connect locking arm 36 to body cross member 34. By the operator first visually confirming planar body surface 84 of body 12 is substantially parallel with ground surface 86, ladder attachment device 10 automatically orients ladder 76 at the recommended 4:1 pitch. The 4:1 pitch is determined by the ratio of a height “G” measured from ground surface 86 to body 12 compared to a distance “H” measured between cylindrical shaped member 90 and a bottom end 102 of ladder 76. Cylindrical shaped member 90 is represented for example as a column shaped pole such as a telephone pole. Ladder attachment device 10 is releasably engaged to cylindrical shaped member 90 by force “F” of a user standing atop ladder 76 near ladder attachment device 10 as previously described herein.

Ladder attachments of the present disclosure offer several advantages including rectangular apertures or similar shaped cavities to receive the legs of a ladder having angular surfaces such as first and second body angled surfaces 48, 50 that automatically align the ladder at a proper pitch such as a 4:1 pitch when the ladder attachment is oriented horizontal with respect to a ground surface. A releasable locking arm such as locking arm 36 having arm angled surfaces such as first and second arm angled surfaces 40, 42 complement body angled surfaces 48, 50 to maintain the 4:1 pitch. Straight, substantially longitudinally stiff wings such as first and second gripper wings 24, 26 provide teeth that can grip trees or poles of different diameters. The gripper wings are deflectable by rotation at their connecting ends such that at least 2 teeth of each of the gripper wings engage the tree or pole so that no further locking device such as a strap, rope, wire, hook, or the like is required to hold the ladder against the tree/pole. First and second gripper wings 24, 26 are substantially inflexible throughout their length; however, the use of reduced thickness “B” at the ends of the first and second gripper wings 24, 26 reduces the part total weight while providing some longitudinal flexibility for the gripper wings.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A ladder attachment, comprising:
an elastomeric member having:
a rigid body including a concave recess created between first and second end legs;
first and second gripper wings each connected at one end to the elastomeric member and extending into the concave recess, each having multiple teeth oriented away from the body, the first and second gripper wings individually separated from the body by first and second slots such that the first and second gripper wings elastically deflect into the first and second slots and toward the body by a force acting on the body; and
the body having first and second apertures individually including first and second body angled surfaces oriented at an acute angle measured with respect to a line extending through the body and perpendicular to a planar body surface of the body.

2. The ladder attachment of claim 1, wherein the acute angle is approximately 15 degrees.

3. The ladder attachment of claim 2, wherein the first and second body angled surfaces when abutting first and second planar body faces of first and second legs of a ladder automatically orient the ladder at an included angle with respect to first and second planar body faces.

4. The ladder attachment of claim 3, wherein the included angle is approximately 105 degrees such that the ladder is oriented at an approximate 4:1 pitch with respect to a cylindrical shaped member engaged by the first and second gripper wings.

5. The ladder attachment of claim 1, further including a locking arm releasably connected to the body and oppositely directed with respect to the teeth.

6. The ladder attachment of claim 1, wherein the locking arm includes first and second arm angled surfaces that correspond in width to the first and second apertures of the body.

7. The ladder attachment of claim 6, wherein the first and second body angled surfaces are oriented parallel to the first and second arm angled surfaces.

8. A ladder attachment, comprising:
an elastomeric member having:
a rigid body including a concave recess created between first and second end legs;
first and second gripper wings individually connected at first and second connecting ends to a body cross member of the body and extending into the concave recess, each having multiple teeth oriented away from the body, the first and second gripper wings individually separated from the body by first and second slots such that the first and second gripper wings elastically deflect into the first and second slots and toward the body by a force acting on the body; and
the first and second gripper wings each have a maximum thickness at the first and second connecting ends at the body cross member, and first and second free ends which are thinner than the first and second connecting ends to provide elastic flexibility of the first and second gripper wings.

9. The ladder attachment of claim 8, wherein the maximum thickness of the first and second gripper wings at the first and second connecting ends is substantially equal to a thickness of the cross member and the body.

10. The ladder attachment of claim 9, wherein the reduced thickness is approximately half of the maximum thickness.

11. The ladder attachment of claim 10, wherein the first and second gripper wings continuously decrease between the maximum thickness and the minimum thickness between the first and second connecting ends and the first and second free ends.

12. The ladder attachment of claim 8, wherein the body includes first and second apertures individually including first and second angled surfaces oriented at an acute angle measured with respect to a line extending through the body perpendicular to a planar body surface of the body.

13. The ladder attachment of claim 8, wherein each of the multiple teeth of each of the first and second gripper wings are aligned on a common straight edge, and each includes a sharp wedge-shaped end, a common length, and a common width.

14. The ladder attachment of claim 8, wherein the first and second slots are arcuate shaped such that an arcuate shaped rear face of each of the first and second gripper wings defines a first radius and an arcuate shaped body face positioned opposite the rear face defines a second radius larger than the first radius.

15. A ladder attachment for connection to a ladder, comprising:
an elastomeric member having:
a rigid body including a concave recess;
a first gripper wing having a first connecting end and a second gripper wing having a second connecting end, the first and second connecting ends integrally attached to the body and extending into the concave recess, each gripper wing having multiple teeth oriented away from the body, the first and second gripper wings individually separated from the body by first and second slots such that the first and second gripper wings elastically deflect into one of the first and second slots and toward the body by a force acting on the body; and
the body having first and second apertures individually including first and second body angled surfaces each oriented at an acute angle measured with respect to a line extending through the body perpendicular to a planar body surface of the body; and
a locking arm releasably connected to the body and oppositely directed with respect to the teeth, the locking arm having first and second arm angled surfaces also oriented at the acute angle, the first arm angled surface aligned with the first aperture and the second arm angled surface aligned with the second aperture, the first and second body angled surfaces aligned parallel to each other and parallel to the first and second arm angled surfaces.

16. The ladder attachment of claim 15, wherein the concave recess is created between first and second end legs of the body, the first and second end legs each extending past an end tooth of the multiple teeth of each of the first and second gripper wings thereby defining a clearance.

17. The ladder attachment of claim 16, wherein the clearance permits the first and second free ends to contact a flat surface without the first or second free ends or the end tooth also contacting the flat surface.

18. The ladder attachment of claim 15, wherein first and second legs of a ladder each received in one of the first or second apertures contact the first and second body angled surfaces to automatically orient the ladder at an included angle with respect to a planar body face of the body.

19. The ladder attachment of claim 18, wherein the included angle is approximately 105 degrees, thereby automatically orienting the ladder at a pitch of approximately 4:1 with respect to a cylindrical shaped member engaged by the first and second gripper wings.

20. The ladder attachment of claim 15, wherein the first and second gripper wings are each oriented at an angle of approximately 30 degrees with respect to a surface of the body to which both gripper wings are connected.
